(19) United States
(12) Patent Application Publication
(10) Pub. No.: US 2012/0292043 A1
(43) Pub. Date: Nov. 22, 2012

(54) DOWNHOLE TOOLS

(75) Inventor: Thomas John Oliver Thornton, London (GB)

(73) Assignee: Volnay Engineering Services Limited, London (GB)

(21) Appl. No.: 13/475,490

(22) Filed: May 18, 2012

(30) Foreign Application Priority Data
May 18, 2011 (GB) 1108324.3

(51) Int. Cl. E21B 17/10; B05D 1/36; B05D 3/02; E21B 43/00; E21B 7/00

(52) U.S. Cl. 166/369; 166/241.1; 175/57; 427/314; 427/419.7

(57) ABSTRACT

There is disclosed a downhole tool or device adapted to include at least part of a well completion assembly or well drilling assembly. For example, an improved centraliser is provided for centralisation of tubulars such as casings, liners, production screens, production tubing and the like in oil/gas wells in other wells, e.g. water wells. An improved downhole tool device is coated with at least first and second coatings, wherein the second coating layer is molecularly bonded to the first coating layer. The first coating comprises at least partly a material selected from the group consisting of Titanium Nitride (TiN), Diamond Like Carbon (DLC) or Carbon, and wherein the second coating at least partly comprises Tungsten Disulfide (WS₂). There is also provided a method of manufacturing a downhole tool or device, wherein the second coating is applied at ambient temperature.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to downhole tools, devices, apparatus, assemblies, or equipment.

The disclosure particularly, though not exclusively, relates to a downhole tool, device or component adapted to comprise at least part of a well completion assembly or well drilling assembly. For example, the disclosure relates to an improved centraliser for centralisation of tubulars such as casings, liners, production screens, production tubing and the like in oil/gas wells in other wells, e.g. water wells. The disclosure also, for example, relates to an improved protector or stabiliser for spacing of tubulars such as drill pipe from rugous bore walls during drilling of oil/gas wells. The disclosure also, for example, relates to an improved tubular, e.g. for use in a well completion, such as a drill pipe, a casing, a liner production screen or a production tubing, e.g. for use in drilling and/or completing a well. The disclosure also, for example, relates to an improved tubular, e.g. for use in well drilling, such as drill pipe.

The disclosure also relates to other downhole tools and equipment, such as downhole intervention, completion and logging equipment.

### BACKGROUND OF THE DISCLOSURE

As a borehole is drilled it is necessary to secure the borehole walls to prevent collapsing and to provide a mechanical barrier to wellbore fluid ingress and drilling fluid egress. This is achieved by cementing in casings. Casings are tubular sections positioned in the borehole, and the annular space between the outer surface of the casing and the borehole wall is conventionally filled with a cement slurry.

After the well has been drilled to its final depth it is necessary to secure a final borehole section. This is performed by either leaving the final borehole section open (termed an open hole completion), or by lining the final borehole section with a tubular such as a liner (hung off the previous casing) or casing (extending to the surface), whereby the annular space between the liner or casing and the borehole is filled with a cement slurry (termed a cased hole completion).

Production tubing is then run into the lined hole and is secured at the bottom of the well with a sealing device termed a “packer” which seals the annulus so formed between the production tubing and the outer casing or liner. At the top of the well the production tubing is fixed to a wellhead/Christmas tree combination. This production tubing is used to evacuate the hydrocarbon.

In some instances instead of running a final liner string, the final borehole section is left open and screens are run. Screens are typically perforated production tubing having either slits or holes. These screens once in position act as a conduit in a procedure to fill the annular void between the borehole wall and the screen by placing sand around the screen. The sand acts as a filter and as a support to the borehole wall. The term used for this operation is “gravel packing”.

In each case centralising or otherwise locating a tubular within a borehole or within another tubular is necessary to ensure tubulars do not strike or stick against the borehole wall or wall of the other tubular, and that a substantially exact matching of consecutive tubulars positioned in the borehole is achieved, while allowing for an even distribution of materials, e.g. cement or sand, placed within the annulus formed. Centralisers or “protectors” for drill strings or drill pipe used to aid in the directing of a drill bit within a borehole are documented. Examples are GB 2 353 549 A (WESTERN WELL TOOL), U.S. Pat. No. 6,250,405 (WESTERN WELL TOOL), and US 2004188147 (WESTERN WELL TOOL).

More recently casing centralisers have been described which aim to keep casing away from the borehole wall and/or aid the distribution of cement slurry in the annulus between the outer surface of the casing and the borehole wall. Examples of casing centralisers are given below.

U.S. Pat. No. 5,095,981 (MIKOLAJCZYK) discloses a casing centraliser comprising a circumferentially continuous tubular metal body adapted to fit closely about a joint of casing, and a plurality of solid metal blades fixed to the body and extending parallel to the axis of the body along the outer diameter of the body in generally equally spaced apart relation, each blade having opposite ends which are tapered outwardly toward one another and a relatively wide outer surface for bearing against the well-bore or an outer casing in which the casing is disposed, including screws extending threadedly through holes in at least certain of the blades and the body for gripping the casing so as to hold the centraliser in place.

EP 0 671 546 A1 (DOWNHOLE PRODUCTS) discloses a casing centraliser comprising an annular body, a substantially cylindrical bore extending longitudinally through said body, and a peripheral array of a plurality of longitudinally extending blades circumferentially distributed around said body to define a flow path between each circumferentially adjacent pair of said blades, each said flow path providing a fluid flow path between longitudinally opposite ends of said centraliser, each said blade having a radial outer edge providing a well-bore contacting surface, and said cylindrical bore through said body being a clearance fit around casing intended to be centralised by said casing centraliser, the centraliser being manufactured wholly from a material which comprises zinc or a zinc alloy.

WO 98/37302 (DOWNHOLE PRODUCTS) discloses a casing centraliser assembly comprising a length of tubular casing and a centraliser of unitary construction (that is, made in one piece of a single material and without any reinforcement means) disposed on an outer surface of the casing, the centraliser having an annular body, and a substantially cylindrical bore extending longitudinally through the body, the bore being a clearance fit around the length of the tubular casing, characterised in that the centraliser comprises a plastic, elastomeric and/or rubber material.

WO 99/25949 (BRUNEL OILFIELD SERVICES) also discloses an improved casing centraliser.

The content of the aforementioned prior art documents are incorporated herein by reference.

As is apparent from the art, many centralisers have been developed to overcome problems pertaining to centralising a tubular and distributing an annulus material. These centralisers are of unitary assembly and are made of a plastic, or more generally, a material such as zinc, steel or aluminium. However, in selecting a single material a trade-off must be made as:
(a) the chosen material must provide a low friction surface against the smooth tubular outermost surface while being strong enough to withstand abrasion from rugous borehole walls;
(b) the chosen material must act as a journal bearing once the centraliser is in its downhole location, but during the running operation it must act as a thrust bearing.

Material such as plastic deforms, and may potentially ride over stop rings or casing collars. This may occur when the centraliser contacts ledges (possibly the ledges within the BOP stack cavities and wellhead) when run in a cased hole, or to ledges and rugous boreholes when run in open hole. The centraliser is driven along the tubular in the opposite axial direction to that of the tubular motion, and is driven into the rings and/or collars. Additionally, when the tubular is rotated (a common procedure when running tubular downhole, converting drag friction to torque friction) the “nose” of the centraliser is forced against a stop-collar and the tubular rotated—thus causing the centraliser nose to act as a thrust bearing. If the centraliser deforms and rides over the collar, the stretched material may jam the centraliser, and possibly the tool or assembly against the borehole wall. This problem is sought to be addressed in WO 02/02904 (BRUNEL OILFIELD SERVICES). The problem is illustrated in cross-section in FIG. 1 thereof.

The content of the aforementioned prior art document is incorporated herein by reference.

It is known that drill pipe connections can be “hard coated” with a material which is harder and more abrasive than the material from which the drill pipe is made so as to protect a drill string. This is because metals of similar hardness used for drill pipe and casing tend to gaul or “pick up”, i.e. cause wear between themselves due to their similar hardness. “Pick up” could be mitigated by coating the drill pipe connections with a harder abrasive material such as Tungsten Carbide. Such has the benefit of acting to reduce wear of the drill pipe—which can be used in a number of wells—but the disadvantage of causing wear to the casing. As wells become deeper this wearing problem becomes more critical. Further, by having a very hard material, such may start to wear off. Whilst it will reduce friction—as it acts to reduce the gauling process—it is not low friction. Typical field observed results of drill pipe steel versus casing friction are of the order of 0.25 to 0.35, even in an oil based or lubricated medium.

Even with improvements to the art, there remains a desire to improve upon known downhole tools. There is also a desire to seek to reduce the aforementioned trade-off requirements.

### SUMMARY

According to a first aspect of an exemplary embodiment of the present invention there is provided a downhole tool or device, at least part of the downhole tool or device being coated with at least first and second coatings.

The first coating may comprise a first coating layer and may comprise an inner an inner coating layer.

The first coating layer may be provided on, e.g. directly on, a surface of the at least part of the downhole tool or device.

The second coating layer may be provided on, directly on, a surface of the inner coating layer.

The second coating layer may be bonded, e.g. molecularly bonded, to or with the first coating layer.

The first coating layer may comprise a first material which may be harder than a material of the at least one part of the tool or device.

The second coating layer may comprise a second material which may have a friction factor (coefficient of friction) which is less than a friction factor (coefficient of friction) of a/the material of the to least one part of the tool or device.

The first coating may comprise at least partly or substantially consisting of a material selected from the group consisting of: Titanium Nitride (TiN), Diamond Like Carbon (DLC) or Carbon, e.g. Physical Vapour Deposited (PVD) Carbon.

The second coating may at least partly or substantially consist of or comprise Tungsten Disulphide (Tungsten Disulfide, WS₂).

Each coating may comprise a single coating layer or a plurality of coating layers.

The second material may advantageously comprise or at least partly or substantially consist of Tungsten Disulphide (Tungsten Disulfide, WS₂).

The first material may alternatively or additionally comprise or at least partly or substantially consist of Titanium Nitride (TiN).

The first material may alternatively or additionally comprise or at least partly substantially consist of Diamond Like Carbon (DLC).

The first material may alternatively or additionally comprise or at least partly or substantially consist of a carbon coating, e.g. a (Physical Vapour Deposited, PVD) carbon coating or hard carbon coating, e.g. Nitron MC High Carbon coating.

The at least part of the device may be made substantially from another material. Advantageously the first material may be harder than the another material. By ‘harder’ may be meant that the at least one of the at least one material or the material has a hardness that is greater than the hardness of the another material.

Advantageously the second material may have a friction factor less than a friction factor of the another material and/or the first material.

According to a second aspect of an embodiment of the present invention there is provided a downhole device or tool, at least part of the tool or device being made from or coated with at least one material or a material selected from one or more from the group consisting of: Titanium Nitride (TiN), Diamond Like Carbon (DLC) or Carbon.

In the case of carbon, the carbon coating may comprise a (Physical Vapour Deposited (PVD) carbon coating or hard carbon coating, e.g. Nitron MC High Carbon coating.

The following optional features may be provided in any of the foregoing aspects of an embodiment of the present invention.

The at least part of the downhole tool or device may comprise at least one surface of the downhole tool or device.

The at least one surface may comprise a bearing surface, e.g. a journal bearing surface and/or a thrust bearing surface.

The downhole tool or device may comprise a tubular member.

The at least one surface may comprise at least part of an innermost surface of the tubular member. Where the at least one material comprises a coating of a single layer of Diamond Like Carbon (or Carbon) the at least one surface may not comprise at least part of an innermost surface of the tubular member.

Additionally or alternatively, the at least one surface may comprise at least part of an outermost surface of the tubular member.

The downhole tool or device may comprise a centraliser, e.g. a casing centraliser. Alternatively, the downhole tool may comprise a centraliser for a liner or screen.

The downhole tool or device may comprise a protector, stabiliser or centraliser, e.g. a production tubing protector, stabiliser or centraliser.

The downhole tool or device may comprise a casing, e.g. a length of casing. In such case the at least part of the downhole tool or device may comprise a joint of the casing, e.g. at least part of an outermost surface of the joint. The joint may have an enlarged diameter as compared to a remainder of the casing.

The downhole tool or device may comprise a liner or production screen. In such case the at least part of the downhole tool or device may comprise a joint of the liner or production screen, e.g. at least part of an outermost surface of the joint. The joint may have an enlarged diameter as compared to a remainder of the liner or production screen.

The downhole tool or device may comprise a drill pipe. In such case the at least part of the downhole tool or device may comprise a joint of the drill pipe, e.g. at least part of an outermost surface of the joint. The joint may have an enlarged diameter as compared to a remainder of the drill pipe.

The downhole tool or device may comprise a tubular body, beneficially a one piece tubular body.

The tubular body may be made from a plastics material, e.g. a polymeric plastics material, and beneficially a thermoplastic.

The tubular body may be made from a metallic material, e.g. steel, iron, ductile iron, zinc or aluminium or an alloy of any of such. Low grade steel is beneficial in view of the price of such.

The tubular body may be made from an elastomeric and/or rubber material. The second coating/coating may act as a (permanent and/or coated on) very low friction dry lubricant. ‘Low friction’ may be comparative to that of another part or a remainder of the downhole tool or device.

The second coating may form a molecular bond with an underlying/substrate material, e.g. the first coating. The second coating may be applied at ambient temperature. The second coating may be of the order of 0.5 μm thick. The coating may be applied by use of a jet or jets of air, e.g. room temperature/ambient air or refrigerated air.

The Inventor believes Tungsten Disulphide to be suitable for robust downhole use providing a very low coefficient of friction (as compared to materials conventionally used to fabricate downhole tools or devices), being chemically inert and withstanding temperatures of up to 650° C.

The second coating may have an extensively modified lamellar composition, which may outperform other dry coating lubricants. The second coating may comprise a dry metallic coating without use of heat, binders or adhesive. The second coating may comprise a lubricant coating which bonds (instantly) to an underlying material, e.g. the first coating, typically with a thickness of around 0.5 μm to 2.0 μm.

The first coating and the second coating may each be single layer or laminar. In the case of a downhole centraliser comprising a casing, liner or screen centraliser or a production tubing centraliser, in a first implementation the downhole centraliser may be adapted to be received on a downhole tubular, in use, so as to be a clearance fit around the downhole tubular such that the downhole centraliser is rotationally and longitudinally moveable relative to the downhole tubular, the downhole centraliser being a rigid tubular body, the tubular body having a first portion and at least one second portion, the first portion and the at least one second portion being statically retained relative to one another, the first portion comprising a tubular member providing an outermost surface of the tubular body, the first portion being substantially formed from a first portion material, and the at least one second portion comprising a ring member provided at or adjacent to one end of the tubular member, the at least one second portion being substantially formed from a second portion material, the first portion material having a lower Young's modulus than the second portion material, and wherein the first portion material substantially comprises a thermoplastic polymer.

The at least one second portion may comprise a further ring member provided at or adjacent to another end of the tubular member. At least a portion of an innermost surface of the tubular body may be provided by the ring member and optional further ring member.

In the case of a downhole centraliser comprising a casing, liner or screen centraliser or a production tubing centraliser, in a second implementation the downhole centraliser may be adapted to be received on a downhole tubular, in use, so as to be a clearance fit around the downhole tubular such that the downhole centraliser is rotationally and longitudinally moveable relative to the downhole tubular, the downhole centraliser being a rigid tubular body, the tubular body having at least one first portion and at least one second portion, the at least one first portion and the at least one second portion being statically retained relative to one another, the at least one first portion comprising at least a portion of an outermost surface of the tubular body, the at least one first portion being substantially formed from a first portion material, and the at least one second portion comprising at least a portion of an innermost surface of the tubular body, the at least one second portion being substantially formed from a second portion material, the first portion material having a lower Young's modulus than the second material, and wherein the first material substantially comprises a thermoplastic polymer.

The at least one first portion may comprise a tubular member providing the outermost surface of the tubular body, the tubular member being substantially formed from the first portion material, and the at least one second portion comprises a further tubular member extending from or adjacent to one end of the tubular member to or adjacent to another end of the tubular member.

The centralisers of the first and second implementations may be termed “composite” centralisers. These centralisers are therefore “non-unitary” in construction, that is to say, they are not formed in one piece from one material. They do, however, offer a centraliser in which parts made from the first portion and second portion materials are static relative to one another, in use. In other words, the centralisers are effectively “one-piece”.

The Inventor has termed centralisers of an exemplary embodiment of the present disclosure the “EZEE-GLIDER” (Trade Mark) centraliser.

The or each first portion may be circumferentially integrally continuous, that is, formed in one piece.

In one implementation the material of the tubular body or first portion material may be a polyphthalamide (PPA), e.g. a glass-reinforced heat stabilised PPA such as AMODEL, available from Solvay Advanced Polymers (see http://www.solvayadvancedpolymers.com).

In another implementation the material of the tubular body or first portion material may be a polymer of carbon monoxide and alpha-olefins, such as ethylene.

Advantageously, the material of the tubular body or first portion material may be an aliphatic polyketone made from co-polymerisation of ethylene and carbon monoxide—optionally with propylene.

The material of the tubular body or first portion material may be selected from a class of semi-crystalline thermoplastic materials with an alternating olefin—carbon monoxide structure.

In a further implementation the material of the tubular body or first material may be a nylon resin. Advantageously the material of the tubular body or first portion material may be an ionomer modified nylon 66 resin. The material of the tubular body or first portion material may be a nylon 12 resin, e.g. RILSAN (Trade Mark) available from Elf Atochem.

In a yet further alternative implementation the material of the tubular body or first portion material may be a modified polyamide (PA).

The material of the tubular body or first portion material may be a nylon compound such as DEVLON (Trade Mark) available from Devlon Engineering Ltd. The material of the tubular body or first portion material may be of the polyetheretherketone family, e.g. PEEK (Trade Mark) available from Victrex PLC.

The material of the tubular body or first portion material may be ZYTEL (Trade Mark) available from Du Pont. ZYTEL (Trade Mark) is a class of nylon resins which, includes unmodified nylon homopolymers (e.g. PA 66 and PA 612) and copolymers (e.g. PA 66/6 and PA 6T/MPMDT etc) plus modified grades produced by the addition of heat stabilizers, lubricants, ultraviolet screens, nucleating agents, tougheners, reinforcements etc. The majority of resins have molecular weights suited for injection moulding, roto-moulding and some are used in extrusion.

Alternatively the material of the tubular body or first portion material may be VESCONITE (Trade Mark) available from Vesco Plastics Australia Pty Ltd.

Alternatively the material of the tubular body or first portion material may be polytetrafluoroethylene (PTFE). In such case the material of the tubular body or first portion material may be TEFLON (Trade Mark) or a similar type material. PTFE or TEFLON (Trade Mark) filled grades of semi-crystalline thermoplastic materials with an alternating olefin—carbon monoxide structure may be used. These materials are suitable for roto-moulding which is a favoured method of manufacture for economic reasons for larger component sizes, e.g. greater than 9% (245 mm). Alternatively, the material of the tubular body or first portion material may be PA66, FG30, PTFE 15 from ALBIS Chemicals.

The outermost surface of said body may provide or comprise a plurality of raised portions.

The raised portions may be in the form of longitudinally extending blades or ribs or may alternatively be in the form of an array of nipples or lobes.

Adjacent raised portions may define a flow path therebetween such that fluid flow paths are defined between first and second ends of the tubular body.

Where the raised portions comprise longitudinal blades, such blades may be formed, at least in part, substantially parallel to an axis of the tubular body.

Alternatively, the blades may be formed in a longitudinal spiral/helical path on the tubular body.

Advantageously adjacent blades may at least partly longitudinally overlap upon the tubular body.

Preferably adjacent blades may be located such that one end of a blade at one end of the tubular body is at substantially the same circumferential position as an end of an adjacent blade at another end of the tubular body.

More preferably, the blades may have an upper spiral portion, a middle substantially straight portion and a lower tapered portion.

The second portion material may be a metallic material.

Preferably, the second portion material may be a bronze alloy such as phosphur bronze or lead bronze, or alternatively, zinc or a zinc alloy.

In a preferred embodiment the second portion material is lead bronze. Bronze is advantageously selected as it has a high Young's Modulus (16,675,000 psi (115,000 MPa)) compared to ZYTEL (around 600,000 psi (4,138 MPa)) and AMODEL (870,000 psi (6,000 MPa)), while having friction properties which are better than steel.

Additionally, the centraliser may include a reinforcing means such as a cage, mesh, bars, rings and/or the like. The reinforcing means may be made from the second material.

At least part of a tool according to an embodiment of the present invention may be formed from a casting process.

Alternatively or additionally, at least part of the tool according to an embodiment of the present invention may be formed from an injection moulding process.

Advantageously, at least part of the tool according to an embodiment of the present invention may be formed from an injection moulding or roto-moulding process.

The second coating/coating may have a coefficient of friction (e.g. non-lubricated or dry coefficient of friction) of less than or equal to 0.1, e.g. in the range 0.030 to 0.070, e.g. 0.030 or 0.070.

The coefficient of friction may be a dynamic coefficient of friction.

The coefficient of friction may be a static coefficient of friction.

The second coating/coating may comprise an outer (e.g. outer facing) surface of at least part of at least part of the tool or device.

According to a third aspect of an embodiment of the present invention there is provided a downhole apparatus or assembly comprising at least one downhole tool or device according to the first or second aspects of embodiments of the present invention.

The downhole apparatus or assembly may comprise a well completion assembly, or drill string, e.g. comprising a plurality of lengths of casing, a plurality of casing centralisers, a plurality of lengths of production tubing and/or a plurality of production tubing centralisers.

The downhole apparatus or assembly may comprise a drilling assembly or drill string, e.g. comprising a plurality of lengths of drill pipe and/or a plurality of drill pipe protectors, centralisers or stabilisers.

According to a fourth aspect of an embodiment of the present invention there is provided a method of drilling a well comprising using a downhole tool or device according to the first or second aspects or a downhole apparatus or assembly according to the third aspect.

According to a fifth aspect of an embodiment of the present invention there is provided a method of completing a well comprising using a downhole tool or device according to the first or second aspects or a downhole apparatus or assembly according to the third aspect.

According to a sixth aspect of an embodiment of the present invention there is provided a method of manufacturing a downhole tool or device according to the first or second aspects of an embodiment of the present invention the method comprising the steps of:

providing at least part of the device;

coating the at least part of the device.

The step of providing at least part of the device may comprise or include heat treating the at least part of the device at or above a temperature T₁.

The step of coating the at least part of the device may comprise applying the coating(s) at a temperature or temperatures T₂.

T₂ may be less that T₁ (T₂<T₁).

T₂ may be ambient or room temperature.

The step of coating the at least one part of the device may comprise or include coating the at least part with at least one or optionally more than one coating or coating layer.

The coating(s) may be selected from one or more of:

Tungsten Disulphide (Tungsten Disulfide, WS₂);

Titanium Nitride (TiN);

Diamond like Carbon;

Carbon, e.g. Physical Vapour Deposited (PVD) Carbon, e.g. Nitron MC.

Advantageously the coating or an outer coating may be Tungsten Disulphide (WS₂).

Where more than one coating layer is provided, advantageously an inner coating layer is harder than the at least part of the device. Where more than one coating layer is provided, advantageously an outer coating layer has a lower coefficient of friction than a/the inner coating layer.

### BRIEF DESCRIPTION OF DRAWINGS

Embodiments of the invention will now be described, by way of example only, and with reference to the accompanying drawings, which are:

FIG. 1 a perspective view from one side and above of a first downhole tool comprising a casing centraliser according to an embodiment of the present invention;

FIG. 2 a side view of a second downhole tool comprising a casing according to an embodiment of the present invention;

FIG. 3 a side view of a third downhole tool comprising a drill pipe according to an embodiment of the present invention;

FIG. 4A a perspective view from one side and one end of a fourth downhole tool comprising a casing centraliser according to an embodiment of the present invention;

FIG. 4B a cross-sectional side view of the downhole tool of FIG. 4A;

FIG. 5A a perspective view from one side and one end of a fifth downhole tool comprising a casing centraliser according to an embodiment of the present invention;

FIG. 5B a cross-sectional side view of the downhole tool of FIG. 5A;

FIG. 6 a side cross-sectional view of a partially drilled borehole of a well including a downhole apparatus comprising a drilling assembly according to an embodiment of the present invention;

FIG. 7 a side cross-sectional view of the borehole of the well of FIG. 6 including the downhole apparatus comprising the drilling assembly subsequent to further drilling;

FIG. 8 a side cross-sectional view of the borehole of the well of FIG. 7 subsequent to the drilling assembly being withdrawn and a further downhole apparatus comprising a casing assembly being located within the borehole of the well;

FIG. 9 a cross-sectional side view of the borehole of the well of FIG. 8 with the drilling assembly relocated;

FIG. 10 a cross-sectional side view of the borehole of the well of FIG. 9 including the drilling assembly subsequent to yet further drilling;

FIG. 11 a cross-sectional side view of the borehole of the well of FIG. 10 including a yet further downhole apparatus comprising a further casing assembly being located within the borehole of the well; and

FIG. 12 a graph of coefficient of friction versus pressure for a material used in the exemplary embodiments of the present invention.

### DETAILED DESCRIPTION OF ILLUSTRATIVE EMBODIMENTS

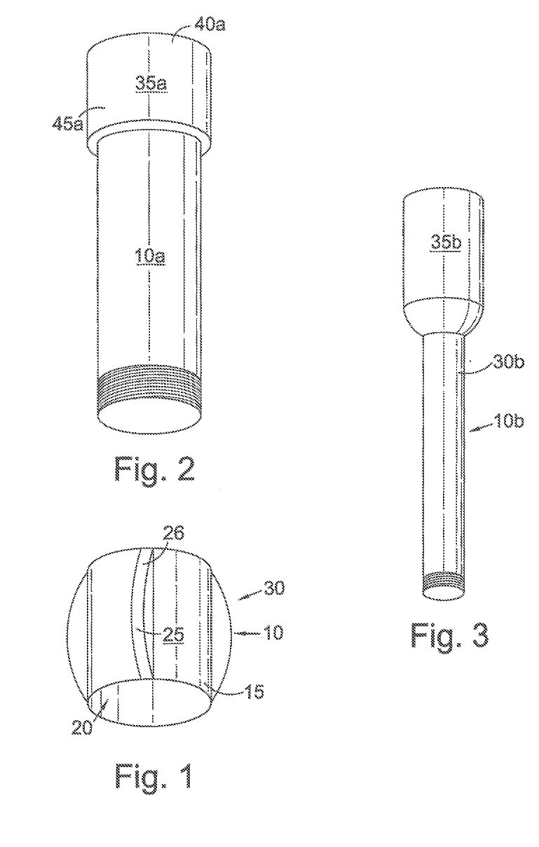

Referring initially to FIG. 1 there is illustrated a downhole tool or device, generally designated 10, according to a first embodiment of the present invention, at least part of the downhole tool or device 10 being coated with at least a first coating and beneficially also with second coating as will be described hereinafter in greater detail.

The at least part of the downhole tool or device 10 comprises at least one surface of the downhole tool or device 10. The at least one surface can comprise a bearing surface, e.g. a journal bearing surface and/or a thrust bearing surface. In this embodiment the downhole tool or device 10 comprises a tubular member 15. In one implementation the at least one surface comprises at least part of an innermost surface 20 of the tubular member 15. However, where the at least one material comprises a coating of a Diamond Like Carbon (or Carbon) the at least one surface does not comprise at least part of an innermost surface of the tubular member 15. Additionally or alternatively, the at least one surface comprises at least part of an outermost surface 25 of the tubular member 15, which part may comprise part of a blade 26.

The downhole tool or device 10 comprises a centraliser 30, in this case a casing centraliser. In an alternative embodiment the downhole tool or device comprises a centraliser for a liner or screen.

In a further alternative embodiment the downhole tool or device comprises a production tubing protector, stabiliser or centraliser.

Referring to FIG. 2 in a yet further alternative embodiment a downhole tool or device 10a comprises a casing, e.g. a length of casing. In such case the at least part of the downhole tool or device 10a comprises a joint 35a of the casing, e.g. at least part 40a of an outermost surface 45a of the joint 35a. The joint 35a has an enlarged diameter as compared to a remainder of the casing.

In a still further alternative embodiment the downhole tool or device comprises a liner or production screen. In such case the at least part of the downhole tool or device comprises a joint of the liner or production screen, e.g. at least part of an outermost surface of the joint. The joint may have an enlarged diameter as compared to a remainder of the liner or production screen.

Referring to FIG. 3, in a still yet further alternative embodiment the downhole tool or device 10b comprises a drill pipe 30b. In such case the at least part of the downhole tool or device 10b comprises a joint 35b of the drill pipe, e.g. at least part of an outermost surface of the joint. The joint 35b has an enlarged diameter as compared to a remainder of the drill pipe.

The downhole tool or device 10;10a;10b comprises a tubular member or body 15;15a;15b, beneficially a one piece tubular body. The tubular body 15;15a;15b can substantially consist of a plastics material, e.g. a polymeric plastics material, and beneficially a thermoplastic. Alternatively the tubular body may be made from a metallic material, e.g. steel, iron, ductile iron, zinc or aluminium or an alloy of any of such. Low grade steel or ductile iron are beneficial in view of the price of such. Alternatively again, the tubular body 15;15a;15b can be made from an elastomeric and/or rubber material.

In use, the second coating comprises a coating and acts as a permanent (coated on) very low friction dry lubricant. The low friction coating can be applied at ambient temperature to form a molecular bond with a substrate material, e.g. the tubular body 15;15a;15b whether plastic or metal. The second coating is typically of the order of 0.5 μm to 2.0 μm. The second coating can be applied by use of a jet or jets of air, e.g. at ambient temperature or refrigerated air.

The Inventor believes Tungsten Disulphide to be suitable for the second coating and for robust downhole use providing a very low coefficient of friction (as compared to materials from which such downhole tools or devices are conventionally made), being chemically inert and withstanding temperatures of up to 650° C. The extensively modified lamellar composition of Tungsten Disulphide outperforms other dry coating lubricants. The coating comprises a dry metallic coating without use of heat, binders or adhesive. The coating comprises a lubricant coating which bonds (instantly) to a substrate material, e.g. plastic, metal, resin, typically with a thickness of around 0.5 μm.

Modified Tungsten Disulphide in laminar form may provide:

a coefficient of friction, e.g. non-lubricated or dry coefficient of friction, of 0.030 dynamic, and 0.070 static;

a load capacity of up to 350,000 psi;

adhesion by molecular bond with no cure time, applied at ambient temperature;

a temperature range providing lubrication from −460° F. to 1200° F. (−273° C. to 650° C.) in normal atmosphere, −350° F. to 2400° F. (−188° C. to 1316° C.) at 10⁻¹⁴ Torr;

chemical stability being inert, non-toxic, corrosion resistant, and non-magnetic;

compatibility with substrates such as ferrous and non ferrous metals, plastics, polymers;

LOX compatibility, being insensitive to detonation by or in presence of oxygen;

a hardness of approximately 30 Rockwell C; and

a thickness of 0.5 μm (0.000020 in).

The coating may be a single layer or laminar.

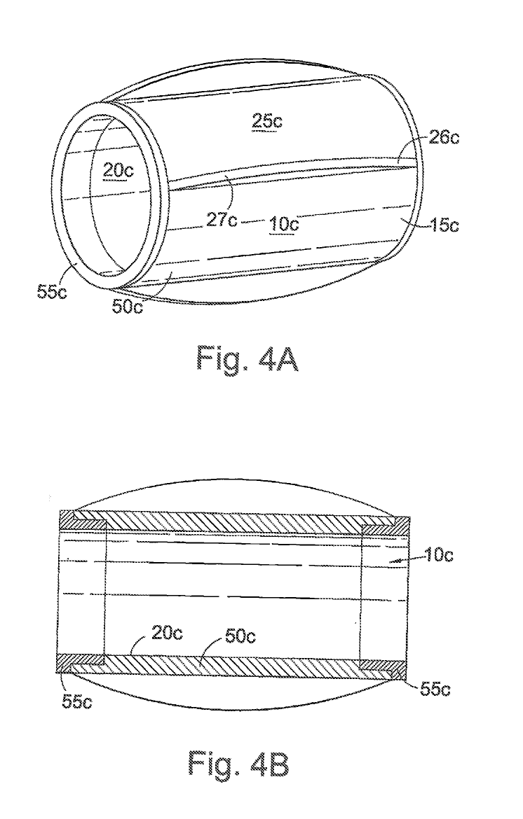

Referring to FIGS. 4A and 4B, there is shown a downhole tool 10c according to a fourth embodiment of the present invention.

In this case the downhole tool 10c comprises a downhole centraliser comprising a casing, liner or screen centraliser or a production tubing centraliser having first (inner) coating and beneficially a second (outer) coating of Tungsten Disulphide over at least part of one or more of outer surface 25 thereof, at least outer surfaces 27c of blades 26c, and/or inner surface 20c. In this implementation the downhole centraliser is adapted to be received on a downhole tubular (not shown), in use, so as to be a clearance fit around the downhole tubular such that the downhole centraliser is rotationally and longitudinally moveable relative to the downhole tubular, the downhole centraliser being a rigid tubular body, the tubular body having a first portion 50c and at least one second portion, the first portion 50c and the at least one second portion 55c being statically retained relative to one another, the first portion 50c comprising a tubular member 15c providing outermost surface 25c of the tubular body, the first portion 50c being substantially formed from a first portion material, and the at least one second portion 55c comprising a ring member provided at or adjacent to one end of the tubular member 15c, the at least one second portion 55c being substantially formed from a second portion material, the first material having a lower Young's modulus than the second portion material, and wherein the first portion material substantially comprises a thermoplastic polymer.

The at least one second portion 55c comprises a further ring member provided at or adjacent to another end of the tubular member. At least a portion of innermost surface 20c of the tubular body is provided by the ring member and optional further ring member.

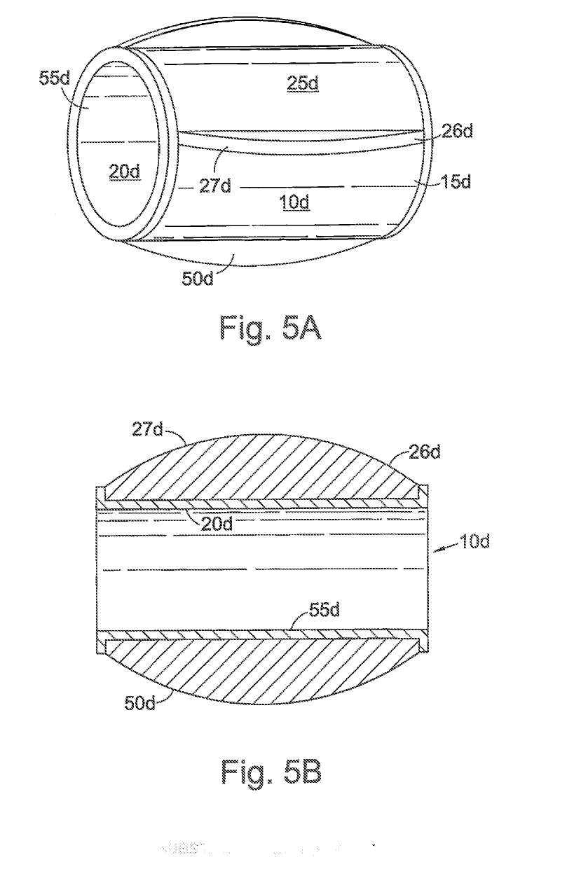

Referring now to FIGS. 5A and 5B, there is shown a downhole tool 10d according to a fifth embodiment of the present invention. In this case the downhole tool 10d comprises a downhole centraliser comprising a casing, liner or screen centraliser or a production tubing centraliser having a first and second coatings applied to at least part of one or more of outer surface 25d, at least outer surfaces 27d of blades 26d and/or inner surface 20d. In this implementation the downhole centraliser is adapted to be received on a downhole tubular (not shown), in use, so as to be a clearance fit around the downhole tubular such that the downhole centraliser is rotationally and longitudinally moveable relative to the downhole tubular, the down hole centraliser being a rigid tubular body, the tubular body having at least one first portion 50d and at least one second portion 55d, the at least one first portion 50d and the at least one second portion 55d being statically retained relative to one another, the at least one first portion 50d comprising at least a portion of an outermost surface of the tubular body, the at least one first portion 50d being substantially formed from a first material, and the at least one second portion 55d comprising at least a portion of an innermost surface of the tubular body, the at least one second portion 55d being substantially formed from a second portion material, the first portion material having a lower Young's modulus than the second portion material, and wherein the first portion material substantially comprises a thermoplastic polymer.

The at least one first portion 50d comprises a tubular member 15d providing the outermost surface of the tubular body, the tubular member 15d being substantially formed from the first portion material, and the at least one second portion 55d comprising a further tubular member extending from or adjacent to one end of the tubular member to or adjacent to another end of the tubular member.

The centralisers of FIGS. 4 and 5 can be termed “composite” centralisers. These centralisers are therefore “non-unitary” in construction, that is to say, they are not formed in one piece from one material. They do however, offer a centraliser in which parts made from the first and second materials are static relative to one another, in use. In other words, the centralisers are effectively “one-piece”.

The Inventor has termed centralisers of an exemplary embodiment the present invention the “EZEE-GLIDER” (Trade Mark) centraliser.

In the embodiments of FIGS. 4 and 5, the or each first portion 50d is circumferentially integrally continuous, that is, formed in one piece. In one implementation the material of the tubular body or first portion material is a polyphthalamide (PPA), e.g. a glass-reinforced heat stabilised PPA such as AMODEL, available from Solvay Advanced Polymers (see http://www.solvayadvancedpolymers.com).

In another implementation the material of the tubular body or first portion material is a polymer of carbon monoxide and alpha-olefins, such as ethylene.

Advantageously, the material of the tubular body or first portion material is an aliphatic polyketone made from co-polymerisation of ethylene and carbon monoxide—optionally with propylene.

Advantageously, the material of the tubular body or first portion material is selected from a class of semi-crystalline thermoplastic materials with an alternating olefin—carbon monoxide structure.

In a further implementation the material of the tubular body or first portion material is a nylon resin. Advantageously the material of the tubular body or first portion material may be an ionomer modified nylon 66 resin. The material of the tubular body or first portion material can be a nylon 12 resin, e.g. RILSAN (Trade Mark) available from Elf Atochem.

In a yet further alternative implementation the material of the tubular body or first portion material is a modified polyamide (PA).

The material of the tubular body or first portion material can be a nylon compound such as DEVLON (Trade Mark) available from Devlon Engineering Ltd.

The material of the tubular body or first portion material can be of the polyetheretherketone family, e.g. PEEK (Trade Mark) available from Victrex plc. The material of the tubular body or first portion material can be ZYTEL (Trade Mark) available from Du Pont. ZYTEL (Trade Mark) is a class of nylon resins which includes unmodified nylon homopolymers (e.g. PA 66 and PA 612) and copolymers (e.g. PA 66/6 and PA 6T/MPMDT etc) plus modified grades produced by the addition of heat stabilizers, lubricants, ultraviolet screens, nucleating agents, tougheners, reinforcements etc. The majority of resins have molecular weights suited for injection moulding, roto-moulding and some are used in extrusion.

Alternatively the material can be VESCONITE (Trade Mark) available from Vesco Plastics Australia Pty Ltd.

Alternatively the material of the tubular body or first portion material can be polytetrafluoroethylene (PTFE). In such case the material can be TEFLON (Trade Mark) or a similar type material. PTFE or TEFLON (Trade Mark) filled grades of semi-crystalline thermoplastic materials with an alternatively olefin-carbon monoxide structure may be used. These materials may be suitable for roto-moulding which is a favoured method of manufacture for economic reasons for larger component sizes, e.g. greater than 9⅝″ (245 mm). Alternatively, the first portion material may be PA66, FG30, PTFE 15 from ALBIS Chemicals.

The outermost surface of said body provides or comprise a plurality of raised portions.

The raised portions are in the form of longitudinally extending blades or ribs or may alternatively be in the form of an array of nipples or lobes.

Adjacent raised portions define a flow path therebetween such that fluid flow paths are defined between first and second ends of the tubular body. Where the raised portions comprise longitudinal blades, such blades form at least in part, substantially parallel to an axis of the tubular body.

Alternatively, the blades form in a longitudinal spiral/helical path on the tubular body.

Advantageously adjacent blades at least partly longitudinally overlap upon the tubular body.

Adjacent blades can be located such that one end of a blade at one end of the tubular body is at substantially the same circumferential position as an end of an adjacent blade at another end of the tubular body.

The blades can have an upper spiral portion, a middle substantially straight portion and a lower tapered portion.

The second portion material is a metallic material. For example, the second portion material can be a bronze alloy such as phosphor bronze or lead bronze, or alternatively, zinc or a zinc alloy. In a preferred implementation the second material is lead bronze. Bronze is advantageously selected as it has a high Young's Modulus (16,675,000 psi (115,000 MPa)) compared to ZYTEL (around 600,000 psi (4,138 MPa)) and AMODEL (870,000 psi (6,000 MPa)) while having friction properties which are better than steel.

Additionally, the centraliser optionally includes a reinforcing means such as a cage, mesh, bars, rings and/or the like. The reinforcing means can be made from the second portion material.

At least part of a tool according to an embodiment of the present invention can be formed from a casting process.

Alternatively or additionally, at least part of the tool according to an embodiment of the present invention is formed from an injection moulding process.

Advantageously, at least part of the tool according to an embodiment of the present invention is formed from an injection moulding or roto-moulding process.

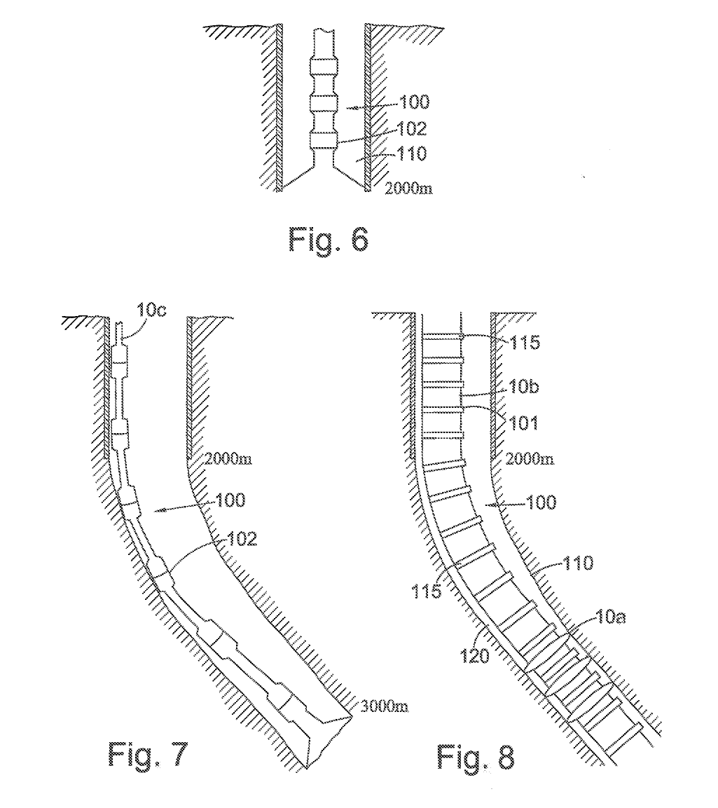

Referring to FIGS. 6 to 11, there is illustrated a downhole apparatus or assembly 100 comprising at least one downhole tool or device 10;10a;10b;10c;10d.

The downhole apparatus or assembly 100 comprises a well completion assembly 101, comprising a plurality of lengths of casing 10a, a plurality of casing centralisers 10, a plurality of lengths of production tubing, and/or a plurality of production tubing centralisers.

The downhole apparatus or assembly 100 also comprises a drilling assembly 102, comprising a plurality of lengths of drill pipe and/or a plurality of drill pipe protectors, centralisers or stabilisers.

In use, an embodiment of the invention provides a method of completing a well comprising using a downhole tool or device 10;10a;10b, and a downhole apparatus or assembly 100.

An embodiment of the invention also provides a method of drilling a well comprising using a downhole tool or device 10b and a downhole apparatus or assembly.

Referring again to FIGS. 6 to 11, an oil/gas/water well 105 is typically drilled in sections, a process that is repeated with the hole size getting smaller each time.

At the end of a drilling section it is customary to run a length of pipe 10b (termed casing if extending back to the surface or liner, if not) into the borehole 110 and to secure the borehole 110 by placing cement in an annulus formed between the outer surface of the pipe 10b and the borehole 110. This operation is termed “cementing”.

An example of this procedure is shown in FIGS. 6 to 11. A casing 10a, typically 13%″ in diameter is set and a hole section is drilled with drill pipe 10b to a desired depth. Casing 10a is then lowered into the well 105. It is shown that the casing 10a is held substantially concentrically in the hole 110 by centralisers 10. Centralisers 10 also assist in the smooth running of the casing 10a, as such are comprised of a low friction material, and thus promote the smooth running of the casing 10a.

It will be noticed that FIG. 8 shows that the centralisation has not been taken all the way back to surface, so collars 115 of the casing 10a may touch a wall 120 of the borehole 110, and the previous casing 10a.

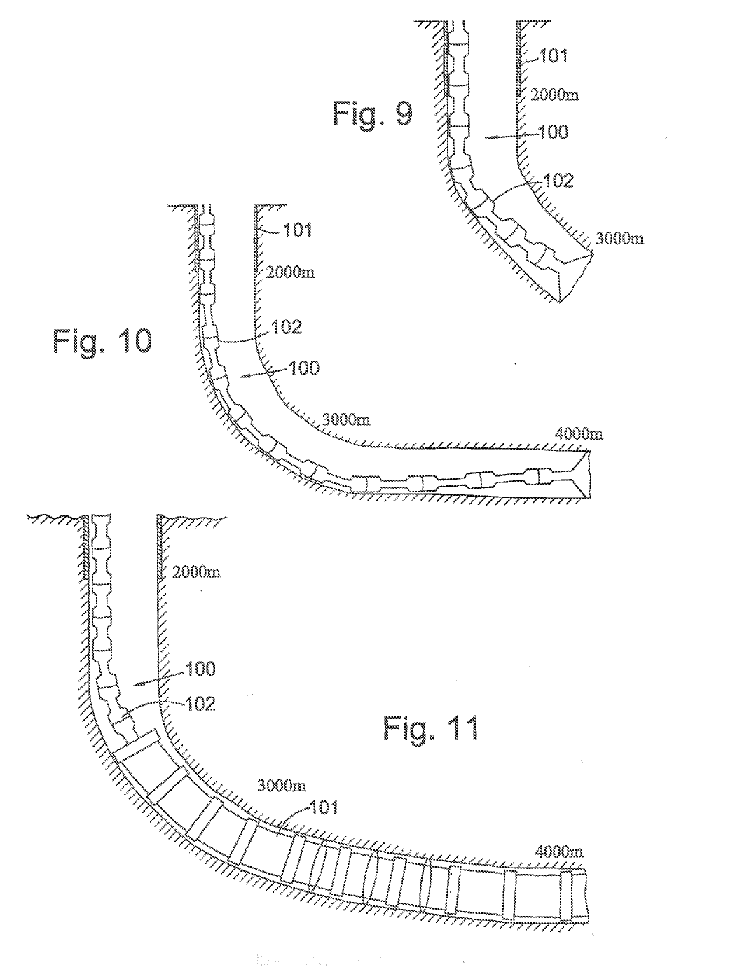

FIGS. 9 and 10 show the procedure being repeated—this time once a 9% casing 10a is cemented in an 8½″ hole section is drilled. It can be seen that the joints 125 of drill pipe 10b will be scraping along the borehole wall section 120, as well as the previous casing 10a. Low friction devices have been designed to be placed on drill pipe 10b to reduce the friction so caused. An example is GB 2 320 045 (KREUGER). However, an embodiment of the present invention is advantageous over such.

FIG. 11 shows a final length of pipe 10a being lowered into the borehole 110. This final pipe 10f is typically not run back to surface, but is secured to the previous casing 10b (via a hanger). This pipe 10f is referred to as a liner. It will be seen that the liner 10f is typically centralised for the length of the borehole 110, but may overlap with the previous casing (termed liner lap), which may or may not be centralised. It is crucial that the liner 10f has the best possible distribution of cement around it, so during the cementation job, the liner 10f is routinely rotated, in an attempt to agitate the cement around the pipe 10f.

Clearly for such an operation to be a success, the pipes 10a,10f need to encounter as low a friction as possible.

It can be understood from the foregoing, that it is desirable to have a low friction environment, both for the drilling of a well, and the running of casings/liners.

When centralisers 10 are used to hold the pipe 10b concentric in the hole 110, the centralisers 10 are beneficially coated in lower friction materials. This assists the casings 10a when being run in hole, as the outer surface of the centralisers are coming in contact with the borehole wall 120. Such also assists in the running of liners 10f as both the outside surface of the centraliser 10 needs to be of a low friction material, but so does the inside surface of the centraliser 10, and the liner 10f is rotated, and thus the centraliser 10 acts as a bearing.

It can also be appreciated that it is advantageous to have the casing collars and drill pipe joints coated with a low friction material, so the whole string of pipe, when run in the hole, acts with the lowest friction possible.

An embodiment of this invention uses a material to coat the surfaces of the casing collars, drill pipe joints and centralisers. An embodiment of the invention can also be extended to coating inside surfaces of the casing to lower the friction of the next hole section.

Typically friction lowering devices have been used in the industry, fitted to both the drill pipe and casing. However, no glue or coating has found to be adequate to withstand the abrasive forces that the pipe undergoes. The downhole temperature can be in excess of 150° C., which will render most glues useless. Typical low friction materials like PTFE (TEFLON (Trade Mark)), Molybdenum Disulphide and graphite are too soft and will readily wear off, and by their very nature are difficult to glue or fix to a material.

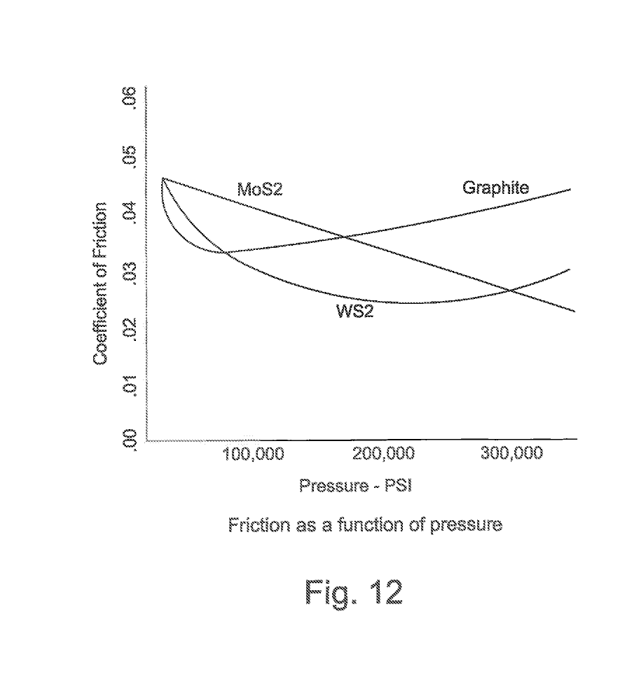

Referring to FIG. 12, the flat plate Tungsten Disulphide has similar or better friction properties when compared to the aforementioned well known lubricants. Tungsten Disulphide typically has a coefficient of friction of around 0.030. This compares to the figure of 0.250 typically recorded as the steel versus steel friction factor when running casing/liner/drill pipe.

The Tungsten Disulphide material is applied by spraying of the material via a jet of ambient temperature air or freezing air to the surface desired. This fixes the molecules physically in place and offers great thermal ranges of stability, and the abrasion resistance matches that of the original surface.

It can therefore be seen that it would be advantageous to coat the outside and inside surfaces of centralisers to give as low a friction factor as possible.

However, by treating the whole casing string or liner as a system or assembly, it can also be seen that:
It is beneficial to coat the outer surface of the casing collars with this material, as the portions that were not centralised would benefit from lower friction.
It is advantageous to coat the drill pipe tool joints in a similar manner, both to assist the running of liners, and lower the friction of the drilling operation.
It is envisaged that by treating the inner surfaces of all casings, that this will provide a low friction environment for both drilling and casing running/liner running process.

Example Coatings

Each of the downhole tools hereinbefore described are provided with a first coating layer and optionally and beneficially a second coating layer.

In one advantageous implementation the second coating, i.e. outer coating, comprises or at least partly or substantially consists of Tungsten Disulphide (Tungsten Disulfide, WS₂). Further, the first, i.e. inner coating, comprises or at least partly or substantially consists of Titanium Nitride (TiN), Diamond Like Carbon, or a Carbon coating such as Physical Vapour Deposited (PVD) Carbon, e.g. Nitron MC. One can:
(a) Coat the part with Diamond Like Carbon (DLC), e.g. a 3.0 μm to 5.0 μm coating. The coating process operates at 220° C. to 300° C., via Plasma Enhanced

Chemical Vapour Deposition (PECVD) giving a coefficient of friction +/−0.1. Such hardens the surface of the device part and thus gives greater abrasion resistance. One can then optionally and advantageously coat the part in WS₂ to further reduce friction. Coat the part in WS₂ to reduce friction. This produces a 0.5 μm thick coating applied at room temperature. WS₂ molecularly interlocks to the device part, i.e. substrate.
(b) Coat the part in Nitron MC (available from Tecvac Ltd). Such a high Carbon coating only 2.0 μm to 4.0 μm thick, applied via a Physical Vapour Deposition (PVD) process and has a coefficient of friction of 0.1 to 0.15. This is carried out at a relatively low temperature process, e.g. 150° C. to 200° C. Again, one can then coat the part with WS₂ or not.
(c) Coat the part in TiN, e.g. a coating thickness of 1 μm to 4 μm. The coating process is high temperature, at 480° C., produced via Physical Vapour Deposition (PVD). However, as its coefficient of friction is 0.4, it will likely be beneficially be coated with WS₂ thereafter.

In any of (a), (b) or (c) above, the outer WS₂ coating layer can molecularly bond to the underlying or inner coating layer.

One of the key points in the method of manufacture of the at least a part of the device is the coating process temperature. If the process temperature is too high, one can alter the mechanical properties of the material (device part) which is coating. For example, if the device part has already been heat treated to say 300° C. (T₁), then applying a coating at 480° C. (T₂) would alter its mechanical properties. However, if the device part had been heat treated to say 600° C. (T₁), applying a coating at 480° C. (T₂) would make no difference.

The at least part of the device is substantially made from another material (e.g. metal), and advantageously the first coating material is harder than the another material. By harder, may be or is meant that the first coating material has a hardness that is greater than the hardness of the material. Advantageously the material has a friction factor less than a friction factor of the another material.

The at least a part of the device can be made from a metallic material, e.g. steel, iron, ductile iron, zinc or aluminium or an alloy of any of such.

The second coating, e.g. Tungsten Disulphide, can act as a permanent (coated on) very low friction dry lubricant. “Low friction” can be comparative to that of the at least part of the device.

The second coating (low friction coating) can be applied at ambient temperature to form a molecular bond with a substrate material, e.g. the second coating (as described further hereinafter).

The second coating, e.g. Tungsten Disulphide, can have a lamella/lamellar, e.g. an extensively modified lamellar composition, which may outperform other dry coating lubricants. The second coating can comprise a dry metallic coating without use of heat, binders or adhesive. The second coating can comprise a lubricant coating which bonds (instantly) to a material of the at least a part. The second coating can be single layer or laminar.

A non-lubricated or dry coefficient of friction of the second material can be around 0.1 or less or the material. Advantageously the friction factor (coefficient of friction) of the material is around 0.090 or less, or 0.070 or less. Advantageously the friction factor (coefficient of friction) of the material is substantially 0.030 to 0.070, e.g. around 0.030 or 0.070.

The at least part of the device can comprise an outer or an inner surface of the at least part of the device.

The material may comprise or at least partly or substantially consist of Tungsten Disulphide.

The coefficient of friction may be a dynamic coefficient of friction, or the coefficient of friction may be a static coefficient of friction.

Tungsten Disulphide (WS₂) is a very low friction coating especially applied at room temperature. The applied coating follows the geometry of the device with no build up on edges. WS₂ can be used on metals and even some plastics. WS₂ can be used on heat treated components and over many engineering coatings. Items up to 2000 kg may be treated.

Typical properties of WS₂ are:

| | |
|---|---|
| Coating Thickness | 0.5 μm |
| Hardness | 30Rc |
| Coefficient of Friction | Dynamic 0.030 |
| | Static 0.070 |
| Colour | Grey |
| Max Operating Temperature | Air −273° C. to 650° C. |
| | Vacuum −188° C. to 1316° C. |

Chemical Inert non toxic
Compatible with solvents, fuels and lubricant oils

Tungsten Disulphide typically has a coefficient of friction of around 0.030. This compares to a figure of 0.250 typically recorded as the steel versus steel friction factor.

The Tungsten Disulphide material can be applied by spraying of the material via a jet of air or freezing air to the desired surface. This fixes the molecules physically in place and offers great thermal ranges of stability, and the abrasion resistance matches that of the original surface.

Tungsten Disulphide is available as a powder that comprises finely divided Tungsten Disulphide particles with a mean particle size ranging between about 1 μm and about 3.0 μm. Tungsten Disulphide adheres to a substrate surface through a molecular mechanical interlock and takes on the characteristic of the substrate regardless of whether the substrate is ferrous, non-ferrous, a composite, carbide or plastic. When applied to a substrate material, Tungsten Disulphide also forms a very thin layer due to the fact that it does not bond to itself. As a result, the dimensions and tolerance of treated parts are not compromised or appreciably affected when a substrate is treated with Tungsten Disulphide. Further, these aspects of Tungsten Disulphide prevent chipping, flaking or contamination problems.

Titanium Nitride (TiN) is a bright gold ceramic coating applied to metallic surfaces by the physical vapour deposition (PVD) process. The coating has high hardness and low friction combined with moderate resistance to oxidisation.

TiN coatings can be produced using a process of electron beam evaporation under vacuum at a work piece temperature of about 48° C. This method of manufacture results in coatings which are very smooth and require no post coating processing. The high hardness and low friction characteristics of the coating combine to make the coating extremely cost effective in the general reduction of device wear.

Typical properties of TiN are:

| | |
|---|---|
| Appearance | Bright gold metallic colour |
| Coating Thickness | 1 μm-4 μm |
| Hardness | 2300Hv |
| Melting Point | 2800° C. |
| Maximum Operating | 500° C. |
| Temperature | |
| Friction Coefficient TiN/TiN | TiN/TiN 0.08-0.25 (Static) |
| | TiN/TiN 0.05-0.15 (dynamic) |
| | TiN/HSS 0.25-0.35 (Static) |
| Corrosion Resistance: | Chemically very inert, insoluble in all |
| | acids except HF. Insoluble in all alkalis. |
| | Oxidation resistance in air to 400° C. |

From the foregoing, it is clear that an embodiment of the present invention provides a method of manufacturing a downhole tool or device, the method comprising the steps of:

providing at least part of the device;

coating the at least part of the device.

The step of providing at least part of the device can comprise heat treating the at least part of the device at or above a temperature T₁. The step of coating the at least part of the device can comprise applying the coating(s) at a temperature(s) T₂, T₃ . . . T₂, T₃ . . . can be less that T₁ (T₂, T₃ . . . <T₁). T₂, T₃ . . . can be ambient or room temperature.

The step of coating the at least one part of the device can comprise coating the at least part with at least one or optionally more than one coating or coating layer.

A first coating(s) can be selected from one or more of:

Titanium Nitride (TiN);

Diamond like Carbon;

Carbon, e.g. Physical Vapour Deposited (PVD) Carbon, e.g. Nitron MC.

Advantageously a second coating or at least the outer coating can be Tungsten Disulphide (WS₂).

It will be appreciated that the embodiments of the present invention hereinbefore described are given by way of example only, and are not meant to limit the scope thereof in any way.

It will, for example, be understood that although the disclosed embodiments of the invention provide a particularly elegant solution to problems in the art, the inventive concept may find use in other downhole tools. Examples of such include downhole intervention tools and equipment, completion tools and equipment, and logging tools and equipment, wireline/stickline/coiled tubing/electric cable/electric line/braided cable tools, e.g. toolstring tools, or running, pulling, shifting or associates tools, fishing tools or mono conductor equipment. Another example is a Sub-sea Safety Valve (SSSV).

An exemplary embodiment of at least one aspect of the present disclosure provides an improved downhole tool or device having a friction factor of the order of ten times less than those known from the prior art, e.g. of the order of 0.100 or less, e.g. 0.030 to 0.070.

An embodiment of at least one aspect of the present disclosure provides an improved or alternative downhole tool or device to that provided in the art.

An exemplary aspect of the present disclosure relates to a new device or tool adapted for use downhole within a bore, or below a wellhead. Accordingly, excluded (or disclaimed) from the scope of the present disclosure is/are devices, tools, apparatus, assemblies or equipment used out of hole or above a wellhead.

1. A downhole tool or device, at least part of the downhole tool or device being coated with at least first and second coatings, wherein the second coating layer is molecularly bonded to or with the first coating layer, the first coating comprises at least partly or substantially consisting of a material selected from the group consisting of: Titanium Nitride (TiN), Diamond Like Carbon (DLC) or Carbon, and wherein the second coating at least partly or substantially consists of or comprises Tungsten Disulfide (WS₂).

2. A downhole tool or device as claimed in claim 1, wherein the first coating comprises a first coating layer and optionally comprises an inner coating layer.

3. A downhole tool or device as claimed in claim 1, wherein the first coating layer is provided on, such as directly on, a surface of the at least part of the downhole tool or device.

4. A downhole tool or device as claimed in claim 1, wherein the second coating comprises a second coating layer and optionally comprises an outer coating layer.

5. A downhole tool or device as claimed in claim 1, wherein the second coating layer is provided on, such as directly on, a surface of the first coating or inner coating layer.

6. (canceled)

7. A downhole tool or device as claimed in claim 1, wherein the first coating layer comprises a first material which is harder than a material of the at least one part of the tool or device.

8. A downhole tool or device as claimed in claim 1, wherein the second coating layer comprises a second material which has a friction factor (coefficient of friction) of a/the material of the at least one part of the tool or device.

9. (canceled)

10. (canceled)

11. A downhole tool or device as claimed in claim 1, wherein the first and/or second coatings are harder than a material from which the at least part of the tool or device is made.

12. A downhole tool or device as claimed in claim 1, wherein the second coating has a friction factor less than a friction factor of the first coating.

13. (canceled)

14. A downhole tool or device as claimed in claim 1, wherein in the case of carbon, the carbon coating material comprises a Physical Vapour Deposited (PVD) carbon coating or hard carbon coating, such as Nitron MC High Carbon coating.

15. A downhole tool or device as claimed in claim 1, wherein the at least part of the downhole tool or device comprises at least one surface of the downhole tool or device.

16. (canceled)

17. (canceled)

18. (canceled)

19. A downhole tool or device as claimed in claim 15, wherein the downhole tool or device comprises a centraliser such as a casing centraliser or a centraliser for a liner or a screen.

20. (canceled)

21. A downhole tool or device as claimed in claim 15, wherein the downhole tool or device is selected from the group consisting of a protector, stabiliser or centraliser, a production tubing protector, stabiliser or centraliser, a casing, a length of casing, a joint of the casing, at least part of an outermost surface of the joint wherein the joint has an enlarged diameter as compared to a remainder of the casing, a liner or production screen, a joint of the liner or production screen, at least part of an outermost surface of the joint, wherein the joint has an enlarged diameter as compared to a remainder of the liner or production screen, a drill pipe comprising a joint of the drill pipe, at least part of an outermost surface of the joint, wherein the joint has an enlarged diameter as compared to a remainder of the drill pipe.

22. (canceled)

23. (canceled)

24. (canceled)

25. (canceled)

26. (canceled)

27. (canceled)

28. (canceled)

29. (canceled)

30. (canceled)

31. A downhole tool or device as claimed in claim 1, wherein the downhole tool or device comprises a tubular body, such as a one piece tubular body.

32. A downhole tool or device as claimed in claim 31, wherein the tubular body is made from a material selected from the group consisting of a plastics material, such as a polymeric plastics material, such as a thermoplastic, an elastomeric and/or rubber material, or a metallic material such as steel, iron, ductile iron, zinc or aluminium or an alloy of any of such, such as low grade steel.

33. (canceled)

34. (canceled)

35. A downhole tool or device as claimed in claim 1, wherein the/a second first coating comprises a coating optionally acting, in use, as a dry lubricant or low friction coating.

36. A downhole tool or device as claimed in claim 35, wherein the low friction coating is applied optionally at ambient temperature to form a molecular bond with a substrate material, such as a/the tubular body.

37. A downhole tool or device as claimed in claims 35, wherein the coating is of the order of 0.5 μm thick.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. A downhole apparatus or assembly comprising at least one downhole tool or device according to claim 1.

77. (canceled)

78. (canceled)

79. A method of completing a well comprising using a downhole tool or device according to claim 1.

80. A method of drilling a well comprising using a downhole tool or device according to claim 1.

81. A downhole tool or device as claimed in claim 1, wherein the first coating comprises Diamond Like Carbon (DLC) or Physical Vapour Deposited (PVD) carbon coating or hard carbon coating.

82. A method of manufacturing a downhole tool or device according to claim 1, the method comprising the steps of:
providing at least part of the device;
coating the at least part of the device.

83. A method as claimed in claim 82, wherein the step of providing at least part of the device comprises or includes heat treating the at least part of the device at or above a temperature T1.

84. A method as claimed in claim 82, wherein the step of coating the at least part of the device comprises applying the coating(s) at a temperature or temperatures T2, wherein T2 is less than T1 (T2<T1).

85. A method as claimed in claim 84, wherein T2 is ambient or room temperature.

86. A method of manufacture of a downhole tool or device comprising the steps of:
providing the at least part of the device;
coating the at least part of the device with at least first and second coatings wherein the first coating at least partly or substantially comprises a material selected from the group consisting of: Titanium Nitride (TiN), Diamond Like Carbon (DLC) or Carbon, and wherein the second coating at least partly or substantially consists of or comprises Tungsten Disulphide, (WS2); and
applying at least the second coating at ambient temperature.

87. A downhole tool or device as claimed in claim 15, wherein the at least one surface comprises a bearing surface such as a journal bearing surface and/or a thrust bearing surface.
